(19) United States
(12) Patent Application Publication
(10) Pub. No.: US 2010/0323315 A1
(43) Pub. Date: Dec. 23, 2010

(54) Orthodontic bracket

(76) Inventor: Kyoto Takemoto, Tokyo (JP)

Correspondence Address: MASUVALLEY & PARTNERS, 8765 AERO DRIVE, SUITE 312, SAN DIEGO, CA, 92123, US

(21) Appl. No.: 12/586,814

(22) Filed: Sep. 28, 2009

(30) Foreign Application Priority Data
Jun. 23, 2009 (JP) 2009-149185

(51) Int. Cl. A61C 7/28

(52) U.S. Cl. 433/10

(57) ABSTRACT

An orthodontic bracket is provided for correcting teeth alignment. The orthodontic bracket allows for not relying on how an operator is skilled in ligation and also for minimizing the friction. The orthodontic bracket includes a slot having an opening into which an orthodontic wire can be inserted, and a shutter that can slide to block or unblock the opening. The orthodontic wire is placed in the slot by causing the shutter to slide and unblock the opening, inserting the wire through the opening, and causing the shutter to slide and block the opening. The orthodontic wire will not disengage from the slot, whereby rotation control, tipping control, and torque control may be reliably performed. Further, it is not necessary to perform ligation that causes the wire to be securely pressed against the bottom of the slot. Since the ligation is not tight, the tooth in question can be smoothly shifted.

This application claims priority under 35 U.S.C. 119 from Japanese patent application serial no. 2009-149185, filed Jun. 23, 2009 entitled “Orthodontic Bracket”, which is incorporated herein by reference in its entirety

### TECHNICAL FIELD

The present invention relates to an orthodontic bracket attached to a tooth to correct teeth alignment.

### BACKGROUND OF THE INVENTION

In recent orthodontics, orthodontic brackets attached to teeth and a wire attached to the brackets have been disposed on the inner side of the teeth, that is, on the lingual side, from an aesthetic point of view. For example, FIG. 1 illustrates a prior art orthodontic bracket 10 which is described in Japanese Examined Patent Publication (Kokoku) No. 57-44967. The orthodontic bracket 10 includes a plate-shaped pad 13 glued to a surface 12 of a tooth 11 that is on the lingual side (inner side) and a bracket body 14 integrated with the pad 13 by brazing or any other suitable method in such a way that the bracket body 14 stands erect from the pad 13 (see FIG. 1).

The bracket body 14 has a portion that looks like three fingers, which forms a main slot opening 15 and a sub-slot opening 16. The main slot opening 15 is positioned vertically downward (when the orthodontic bracket 10 is used in the maxilla) or upward (when the orthodontic bracket 10 is used in the mandible) in a state in which the orthodontic bracket 10 is attached to the lingual surface of the tooth 11. The sub-slot opening 16 horizontally toward the lingua when the orthodontic bracket 10 is attached as described above. A metal wire 17 made of, for example, an alloy and having a rectangular or any other suitable cross-sectional shape is then inserted into the slot 15 or 16.

The intrinsic elasticity of the wire 17 produces a bending force, a tension, or any other force as a restoring force that serves as a corrective force or moment acting on the tooth 11, which deviates from a normal dental arc or is skewed incorrectly, and the force or moment shifts or rotates the tooth 11 over time to a position on the normal dental arc. Further, undercut portions 18 and 19 formed as upper and lower gaps between the bracket body 14 and the pad 13 are used to catch a thin wire, a rubber band, or any other suitable fastener for ligating and securing the wire 17 inserted into the main slot 15 (or the sub-slot 16) to the orthodontic bracket 10.

FIG. 2 shows another prior art orthodontic bracket 20, which is described in U.S. Pat. No. 4,337,037. The orthodontic bracket 20 includes a pad 13, similar to the one used in the orthodontic bracket 10 of FIG. 1, and a bracket body 24 integrated with the pad 13. The bracket body 24 may include a main slot opening 25 positioned horizontally toward the lingua in a state in which the orthodontic bracket 20 is attached to the tooth 11, as shown in FIG. 2. Further, similar to the orthodontic bracket 10 of FIG. 1, upper and lower undercut portions 18 and 19 are formed between the bracket body 24 and the pad 13, and at least one of the undercut portions can be used to ligate and secure a wire 17, which is inserted in a predetermined position in the main slot opening 25.

When any of the orthodontic brackets of the prior art described above is used to perform lingual orthodontics, it has been pointed out that the ligation is a cumbersome task. In particular, an orthodontic bracket used in the maxilla and having a large anterior tooth torque does not provide a force large enough to press the wire to the bottom of the slot, and a single tie results in a poor ligation. In this case, ligation using double over tie, which is more cumbersome, has been used. When a small-sized orthodontic bracket is used, since the width of the slot is narrow and the depth thereof is shallow, it is important to perform ligation very carefully in order to reliably press the wire into the slot. If the ligation is loose, the play between the slot and the wire is large, which adversely affects rotation and torque control.

An orthodontic bracket having a horizontally oriented slot is problematic, for example, in that loose ligation may not allow improvement in rotation or may cause the wire to disengage from the slot during anterior retraction, resulting in torque control failure. On the other hand, when an orthodontic bracket having a vertically oriented slot is used, loose ligation may not allow tipping, height control, or sufficient torque control as well. As a result, in both the horizontally and vertically oriented slots, loose ligation prevents reliable three-dimensional tooth control. On the other hand, tight ligation that allows the wire to be securely pressed against the bottom of the slot may increase the friction between the wire and the ligation wire, preventing smooth tooth motion.

### SUMMARY OF THE INVENTION

To solve the problems described above, an object of the present invention is to provide an orthodontic bracket that does not rely on how an operator is skilled in ligation and can minimize the above mentioned friction.

A first aspect of the present invention is an orthodontic bracket attached to a tooth to correct the row of teeth, the orthodontic bracket comprising a slot having an opening into which a wire can be inserted in the vertical direction, and a shutter that can slide to block or unblock the opening. The wire is placed in the slot by causing the shutter to slide and unblock the opening, inserting the wire through the opening, and causing the shutter to slide and block the opening.

According to a second aspect of the present invention, the slot has a square cross-sectional shape.

According to a third aspect of the present invention, the length of the slot ranges from 1.0 to 2.0 mm or from 2.0 to 3.5 mm.

According to a fourth aspect of the present invention, the position of the center of the slot is determined in such a way that the ratio of the distance from the crown lower end to the crown height ranges from 0.2 to 0.5 or from 0.3 to 0.7.

According to the first aspect of the present invention, the wire will not disengage from the slot, whereby the torque control can be reliably performed. Further, it is not necessary to perform ligation that causes the wire to be securely pressed against the bottom of the slot. Since the ligation is not tight, the tooth in question can be smoothly shifted.

According to the second aspect of the present invention, the play between the wire and the slot in the horizontal direction can be the same as that in the vertical direction.

According to the third aspect of the present invention, an optimum corrective force and moment can be obtained.

According to the fourth aspect of the present invention, it is possible to use a wire having a straight configuration including a simple smooth curve, such as an arc, and straight lines connected to both ends of the curve.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 is a side view of a prior art orthodontic bracket.

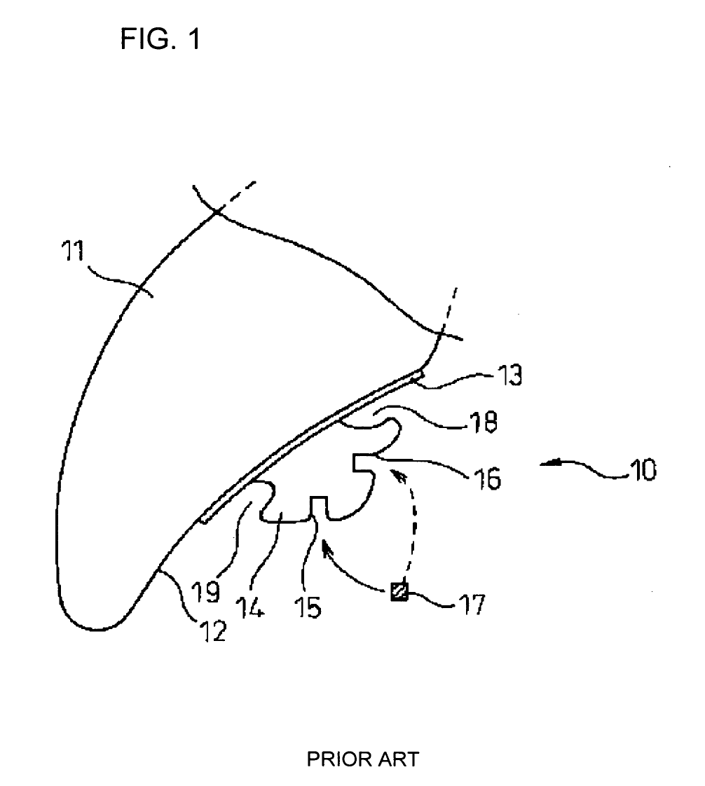

FIG. 2 is a side view of another prior art orthodontic bracket.

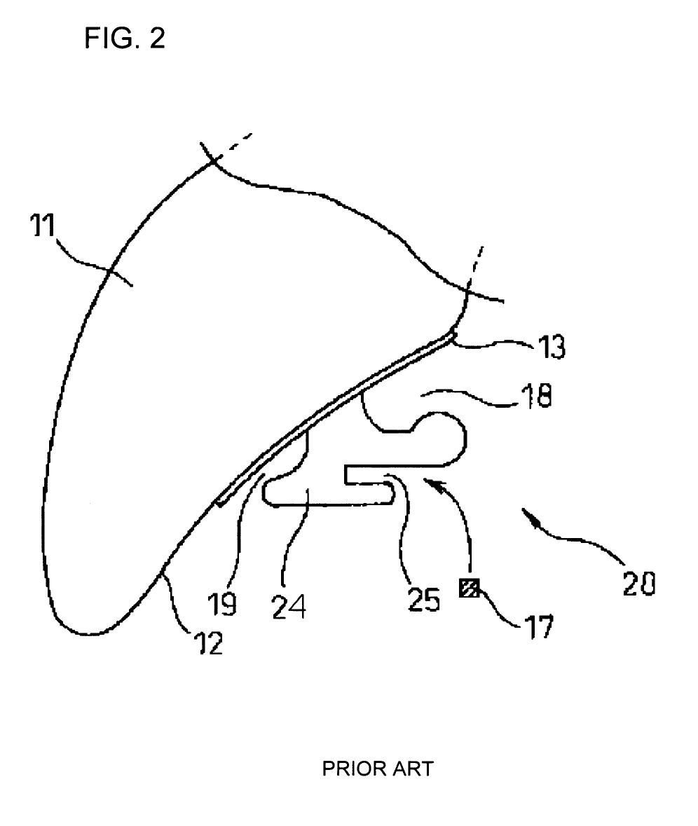

FIGS. 3A, 3B, and 3C are a plan view, a side view, and a bottom view of an orthodontic bracket according to an embodiment of the invention.

FIG. 4 is a plan view of a wire useable with the orthodontic bracket shown in FIGS. 3A-3C.

In the appended figures, the portion having the same or similar functions may have the same reference label and no redundant description thereof will be made in the present specification.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing the preferred exemplary embodiment(s) of the disclosure. It should be understood that various changes may be made in the function and arrangement of elements without departing from the spirit and scope of the invention as set forth in the appended claims.

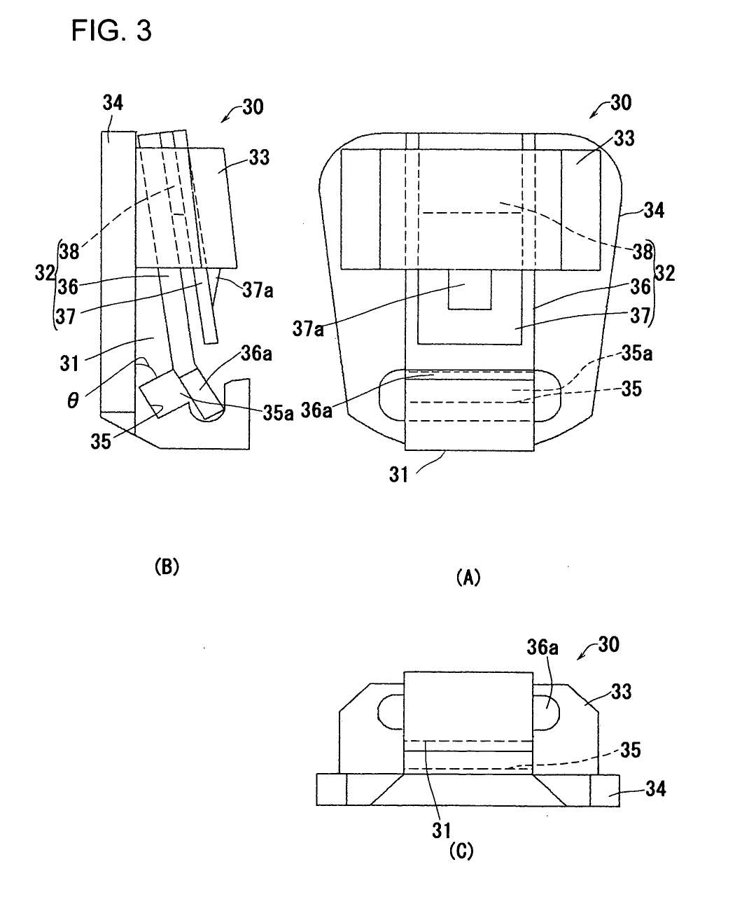

FIGS. 3A, 3B, and 3C represent, respectively, a plan view, a side view, and a bottom view of an orthodontic bracket according to the embodiment of the present invention. The orthodontic bracket may 30 include a bracket body 31, a shutter 32, a shutter holder 33, and a pad 34.

The bracket body 31 features a slot 35 formed therein, to which a wire 40, which will be described later, is attached. The slot 35 has a square cross-sectional shape and has a short length. In addition, the slot 35 includes an opening 35a into which the wire can be inserted in the vertical direction. Conversely, the slot of the orthodontic bracket of the prior art has a rectangular cross-sectional shape. When a thin, round wire is used to perform leveling, in particular, the play between the horizontally oriented slot and the wire is large, and hence sufficient improvement in rotation often cannot be made. To mitigate this problem, the slot 35 of the orthodontic bracket 30 of the present embodiment has a square cross-sectional shape and has a short length so that three-dimensional control including rotation control, tipping control, and torque control may be performed with low friction.

The play between the slot 35 and the wire 40 in the horizontal direction is the same as that in the vertical direction, which is significantly advantageous in improving the rotation control, tipping control, and torque control, as compared to a rectangular slot of the prior art.

The length of one side of the square cross-sectional shape of the slot preferably ranges from about 0.015 to 0.019 inches. When the length of one side is within this range, an optimum corrective force and moment can be obtained by adjusting the length of the slot, the distance between the brackets, the size of the wire, and other parameters.

The length of the slot 35 can be about, for example, 1.5 mm when the orthodontic bracket 30 is used in the maxilla, whereas it can be about 1.3 mm when used in the mandible.

It is however noted that the length of the slot is not limited to the values described above. The length of the slot 35 preferably ranges from about 1.0 to 2.0 mm. When the length of the slot is within this range, an optimum corrective force and moment can be obtained by adjusting the length of one side of the square cross-sectional shape of the slot, the distance between the brackets, the size of the wire, and other parameters.

As described above, the length of the slot of the orthodontic bracket of the present embodiment can be shorter than the length of the slot of an orthodontic bracket of the prior art.

Since the length of the slot of the orthodontic bracket of the present embodiment is shorter than the length of the slot of an orthodontic bracket of the prior art, the following advantages are provided. First, reducing the length of the slot allows the distance between adjacent brackets to be increased. Thus, a large distance between adjacent brackets prevents the wire from being plastically deformed due to a large magnitude of stress acting thereon. Second, no plastic deformation results in any increase in friction.

The torque θ of the slot 35, shown in FIG. 3B, preferably ranges from about 40 to 70 degrees. When the torque θ of the slot is within this range, the orthodontic bracket 30 may be attached to a tooth in accordance with the form thereof.

The slot 35 is formed in the bracket body 31 in such a way that the opening 35a of the slot 35 is oriented in a substantially vertical direction, whereby the wire 40 is readily placed in the slot 35 and at the same time the wire 40 is readily bent in this process.

As shown FIG. 3B, the slot 35 is positioned in a lower portion of the orthodontic bracket 30. The orthodontic bracket 30 is attached to the tooth in such a way that the slot 35 is positioned on the labial side.

The vertical position of the centroid of the square cross-sectional shape of the slot 35 is now defined as the “position of the center of the slot.” The ratio of the distance from the lower end of the crown of the tooth to the height of the crown is further defined as the “ratio of the distance from the crown lower end to the crown height.” The position of the center of the slot is preferably determined in such a way that the ratio of the distance from the crown lower end to the crown height ranges from about 0.2 to 0.5. When the position of the center of the slot is determined in this way, a wire having a “straight configuration” formed of a simple smooth curve, such as an arc, and straight lines connected to both ends of the curve may be advantageously used.

The shutter 32 is attached to the bracket body 31 via the shutter holder 33 so that the shutter 32 slides to block or unblock the opening 35a of the slot 35. The shutter 32 includes a rectangular plate-shaped shutter body 36, a rectangular plate-shaped stopper 37, and a rectangular plate-shaped spacer 38. A lid 36a that blocks or unblocks the opening 35a of the slot 35 is formed at the lower end of the shutter body 36. A tab 37a is formed at the lower end of the stopper 37 so that the shutter 32 does not disengage from the shutter holder 33.

The shutter body 36 and the stopper 37 are overlaid with the spacer 38 interposed therebetween at the upper end thereof and joined with each other. The shutter holder 33 has a U-like cross-sectional shape; the upper end of the shutter 32 is inserted into the U-shaped portion, and both ends of the U-shaped portion are joined with the pad 34. When the lid 36a of the shutter body 36 blocks the opening 35a of the slot 35, the tab 37a of the stopper 37 abuts the shutter holder 33 and hence the shutter 32 does not disengage from the shutter holder 33. In this way, the lid 36a is reliably secured to cover the opening 35a of the slot 35, and serves as a sturdy inner wall of the slot 35. Pressing the lower end of the stopper 37 toward the shutter body 36 so that the stopper 37 is bent and lifting the lower end of the stopper 37 cause the tab 37a of the stopper 37 to enter the U-shaped portion of the shutter holder 33. Since the shutter 32 can thus be lifted, the lid 36a of the shutter body 36 unblocks the opening 35a of the slot 35.

When torque control is performed, the configured slot 35 does not allow the wire 40 to disengage from the slot 35 during anterior retraction. Therefore, even when the wire 40 has a square cross-sectional shape, the play in the torque is small and the torque control can be sufficiently performed. Among others, since the low friction provides a smaller continuous corrective force, smooth tooth motion is likely achieved. Furthermore, since the smaller force provides a sufficient corrective force, the pain that the patient may feel at the tooth under orthodontic treatment is likely reduced.

The pad 34 has a rectangular plate shape and is integrated with the bottom of the bracket body 31 by brazing or any other suitable method. The pad 34 is glued or otherwise attached to the lingual-side surface of the tooth. Since the pad 34 is thin and attached to a portion close to the gingiva, even when the orthodontic bracket 30 is attached to an anterior tooth in the maxilla and faces the tip of an anterior tooth in the mandible, the tip of the anterior tooth in the mandible does not tend to hit the orthodontic bracket 30. Therefore, since the orthodontic bracket 30 will not come into contact with the tip of any anterior tooth in the mandible, no gap will be formed between upper and lower molar teeth, whereby there is no risk of root resorption at the anterior tooth. It should be noted that when the pad 34 is glued onto the lingual-side surface of a tooth, any indentation in the surface of the tooth can be filled with an adhesive or the angle of the surface of the pad 34 to the surface of the tooth can be delicately adjusted by using an adhesive.

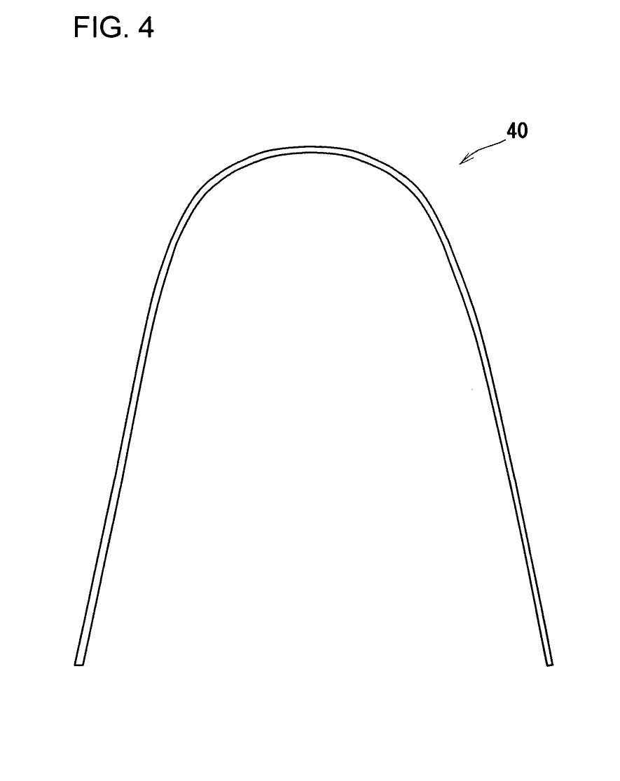

The wire 40 is a straight arch-shaped wire, smoothly curved at a large radius of curvature with no sharply bent portion, which requires almost no additional bending force to produce plastic deformation. The wire 40 has a straight configuration formed of a simple smooth curve, such as an arc, and straight lines connected to both ends of the curve without any step between the curve and the straight lines. Additionally, the wire 40 has no bent portion through plastic deformation, and rests entirely in a horizontal plane when it is not biased, as shown in FIG. 4. When the wire 40 is attached to a tooth for correction, the wire 40 is deformed within its elasticity limit (when a wire made of a shape memory alloy is used, the wire is deformed within its super-elasticity limit) and inserted into the slot 35 of the orthodontic bracket 30. The elastic force of the wire 40 then produces a corrective force or moment acting on the tooth via the orthodontic bracket 30.

Since this configured wire 40 does not need in advance any plastically deformed bent portion, the wire 40 may be readily produced and industrially manufactured in volume, providing a significant advantage of cost reduction. Further, when the position of the wire 40 is shifted and adjusted relative to the orthodontic bracket 30 in the course of orthodontic treatment, no cumbersome operations, such as re-bending any bent portion and re-ligation, are necessary, unlike the mushroom-shaped archwire of the prior art, whereby the sliding adjustment of the wire 40 is very readily carried out. Therefore, the burdens on both the operator and patient are reduced, and additionally the effect of individual skills among the operators is relatively reduced. Further, the fact that it is not basically necessary to bend the wire 40 so that the shape thereof conforms to the dental arch of each individual patient is significantly advantageous. This advantage lies in a fact that it is possible to use a material which more flexibly undergoes super-elastic deformation compared to a wire of the prior art which is extremely difficult to be bent through plastic deformation, such as a shape memory alloy made of nickel, titanium, copper, or other elements.

It should be noted that when the orthodontic bracket of the present embodiment is used in treatments, the chair time and treatment time are shortened. Additionally, shifting a tooth, such as tipping control and rotation control, is also reliably performed in a short period of time. More specifically, this period of time is reduced by an amount of about 10 to 40% compared to a case where an orthodontic bracket of the prior art is used.

While, in this embodiment, the orthodontic bracket 30, pertaining to the present invention, is attached to the lingual side of the tooth, in other embodiments the orthodontic bracket 30 may be attached to the labial side of the tooth.

In this embodiment, the length of one side of the square cross-sectional shape of the slot 35 preferably ranges from about 0.018 to 0.022 inches. When the length of one side is within this range, an optimum corrective force and moment may be obtained by adjusting the length of the slot 35, the distance between the brackets, the size of the wire, and other parameters.

The length of the slot 35 preferably ranges from about 2.0 to 3.5 mm. When the length of the slot is within this range, an optimum corrective force and moment may be obtained by adjusting the length of one side of the square cross-sectional shape of the slot, the distance between the brackets, the size of the wire, and other parameters.

The torque θ of the slot 35 preferably ranges from about −5 to 30 degrees. When the torque θ of the slot 35 is within this range, the orthodontic bracket 30 can be attached to a tooth in accordance with the form thereof. Depending on the value of the torque θ, it is possible to provide, as appropriate, an opening 35a into which a wire may be horizontally inserted and a shutter 32 that can slide to block or unblock the opening 35a.

The position of the center of the slot 35 is preferably determined in such a way that the ratio of the distance from the crown lower end to the crown height ranges from about 0.3 to 0.7.

1. An orthodontic bracket comprising:
a slot having an opening into which an orthodontic wire can be inserted; and
a shutter that can slide to block or unblock the opening,
wherein the orthodontic wire is placed in the slot by causing the shutter to slide and unblock the opening, inserting the wire through the opening, and causing the shutter to slide and block the opening.

2. The orthodontic bracket according to claim 1, wherein the slot has a square cross-sectional shape.

3. The orthodontic bracket according to claim 1, wherein a length of the slot ranges from about 1.0 to 2.0 mm or from about 2.0 to 3.5 mm.

4. The orthodontic bracket according to claim 1, wherein a position of center of the slot is determined using a ratio of distance from a crown lower end to a crown height ranging from about 0.2 to 0.5 or from about 0.3 to 0.7.

5. The orthodontic bracket according to claim 1, wherein a torque θ of the slot ranges from about 40 degrees to about 70 degrees or from about −5 degrees to about 30 degrees.

6. The orthodontic bracket according to claim 1, wherein the opening of the slot is oriented in a substantially vertical direction.

7. The orthodontic bracket according to claim 1, wherein the shutter comprises:
a rectangular plate-shaped shutter body;
a rectangular plate-shaped stopper; and
a rectangular plate-shaped spacer.

8. The orthodontic bracket according to claim 7, wherein the shutter body and the stopper are overlaid with the spacer being interposed therebetween and joined with each other at an upper end of the shutter.

9. The orthodontic bracket according to claim 7, wherein the shutter body further comprises a lid at its lower end for blocking or unblocking the opening of the slot.

10. The orthodontic bracket according to claim 7, wherein the orthodontic bracket further comprises a shutter holder so as to attach the shutter with a bracket body.

11. The orthodontic bracket according to claim 10, wherein the stopper further comprises a tab formed at its lower end that abuts the shutter holder when the lid of the shutter body blocks the opening.

12. The orthodontic bracket according to claim 10, wherein the slot is positioned in a lower portion of the bracket body.

13. The orthodontic bracket according to claim 10, wherein the shutter holder has a u-like cross-sectional shape such that the upper end of the shutter is inserted into a u-shaped portion and both ends of the u-shaped portion are joined with a pad.

14. The orthodontic bracket according to claim 13, wherein the pad has a rectangular plate shape which is integrated with bottom of the bracket body.

15. An orthodontic wire having an arch-shaped portion and two straight portions attached to both ends of the arch-shaped portion without any step therebetween such that the orthodontic wire rests entirely in a horizontal plane when it is not biased.

16. The orthodontic wire according to claim 15, wherein the arch-shaped portion is smoothly curved within its elasticity limit with no sharp edges and no sudden radius change.

17. An orthodontic bracket system comprising:
an orthodontic wire having an arch-shaped portion smoothly curved within its elasticity limit and two straight portions attached to both ends of the arch-shaped portion, wherein the orthodontic wire has no sharp edges and no sudden radius change;
a plurality of orthodontic brackets, wherein each of the plurality of orthodontic brackets comprises:
a slot having an opening with a square cross-sectional shape, wherein a length of the slot ranges from about 1.0 to 2.0 mm or from about 2.0 to 3.5 mm,
a shutter that can slide to block or unblock the opening, and
a shutter holder so as to attach the shutter with a bracket body, wherein the orthodontic wire is placed in the slot by causing the shutter to slide and unblock the opening, inserting the wire through the opening, and causing the shutter to slide and block the opening.

18. The orthodontic bracket system according to claim 17, wherein a position of center of the slot is determined using a ratio of distance from a crown lower end to a crown height ranging from about 0.2 to 0.5 or from about 0.3 to 0.7.

19. The orthodontic bracket according to claim 17, wherein a torque θ of the slot ranges from about 40 degrees to about 70 degrees or from about −5 degrees to about 30 degrees.

20. The orthodontic bracket system according to claim 17, wherein the shutter comprises:
a rectangular plate-shaped shutter body having a lid at its lower end for blocking or unblocking the opening of the slot;
a rectangular plate-shaped stopper; and
a rectangular plate-shaped spacer, wherein the shutter body and the stopper are overlaid with the spacer being interposed there between and joined with each other at an upper end of the shutter.
